(19) United States
(12) Patent Application Publication
(10) Pub. No.: US 2006/0181644 A1
(43) Pub. Date: Aug. 17, 2006

(54) Spatial image conversion

(76) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,056

(22) PCT Filed: Mar. 31, 2004
(86) PCT No.: PCT/IB04/50372

§ 371 Date: Oct. 4, 2005

(30) Foreign Application Priority Data
Apr. 10, 2003 (EP) 03100978.0

(51) Int. Cl. H04N 7/01

(52) U.S. Cl. 348/458

(57) ABSTRACT

The invention relates to an image conversion unit (200) for converting an input image with a first resolution into an output image with a second resolution being different from the first resolution. The image conversion unit (200) comprises: a coefficient-determining means (106) for determining a first filter coefficient on basis of pixel values of a group of pixels of the first image; combining means (204-210) for combining the first filter coefficient with a predetermined filter coefficient into a final filter coefficient; and an adaptive filtering means (104) for computing a second pixel value of the second image on basis of a first one of the pixel values of the first image and the final filter coefficient.

The invention relates to an image conversion unit for converting a first image with a first resolution into a second image with a second resolution being different from the first resolution, the image conversion unit comprising:

a coefficient-determining means for determining a first filter coefficient on basis of pixel values of a group of pixels of the first image; and

an adaptive filtering means for computing a second pixel value of the second image on basis of a first one of the pixel values of the first image and the first filter coefficient.

The invention further relates to an image processing apparatus, comprising:

receiving means for receiving a signal corresponding to a first image; and

an image conversion unit for converting the first image into a second image, as described above.

The invention further relates to a method of converting a first image with a first resolution into a second image with a second resolution being different from the first resolution, the method comprising:

determining a first filter coefficient on basis of pixel values of a group of pixels of the first image; and

computing a second pixel value of the second image on basis of a first one of the pixel values of the first image and the first filter coefficient.

The invention further relates to a computer program product to be loaded by a computer arrangement, comprising instructions to convert a first image with a first resolution into a second image with a second resolution being different from the first resolution.

The advent of HDTV emphasizes the need for spatial up-conversion techniques that enable standard definition (SD) video material to be viewed on high definition (HD) television (TV) displays. Conventional techniques are linear interpolation methods such as bi-linear interpolation and methods using poly-phase low-pass interpolation filters. The former is not popular in television applications because of its low quality, but the latter is available in commercially available ICs. With the linear methods, the number of pixels in the frame is increased, but the perceived sharpness of the image is not increased. In other words, the capability of the display is not fully exploited.

Additional to the conventional linear techniques, a number of non-linear algorithms have been proposed to achieve this up-conversion. Sometimes these techniques are referred to as content-based, content adaptive or edge dependent spatial up-conversion. A number of these up-conversion techniques have been described in an overview article “Towards an overview of spatial up-conversion techniques”, by Meng Zhao et al., in the proceedings of the ISCE 2002, Erfurt, Germany, 23-26 Sep. 2002.

Content-adaptive image up scaling as described in these documents, has proven to give a greatly improved sharpness impression compared to linear up-conversion methods based on the sampling theorem. Drawback of these methods, however, is that they are not necessarily optimal in a subjective sense and they do not come with a clue as to how improve on this aspect of their performance.

It is an object of the invention to provide an image conversion unit of the kind described in the opening paragraph, which is arranged to provide images that are optimal in a subjective sense.

This object of the invention is achieved in that the image conversion unit comprises control means to control the determining of the first filter coefficient. By providing an interface to the coefficient-determining means the adaptive filtering can be controlled externally and hence the filtering is not only dependent on the actual image content but also dependent on additional control data. This control data might be provided directly by a user who is watching the second image or an image being derived from the second image. Preferably the control data is provided by means of selection from sets of control data corresponding to respective predetermined tastes. Alternatively the conversion is controlled on basis of meta data of the image, e.g. the type or genre of the image. For example the amount of sharpness improvement is higher in the case of images representing a cartoon than in the case of images representing a football match.

An embodiment of the image conversion unit according to the invention is characterized in being arranged to compute the first filter coefficient by combining a second filter coefficient, which is based on the pixel values of the group of pixels, with a predetermined filter coefficient, the combining controlled by the control means. That means that the first filter coefficient is based on two components: the second filter coefficient and the predetermined filter coefficient. In other words, the first filter coefficient is based on the actual image content and based on a fixed value, respectively. The ratio between these components determines the filtering and e.g. the sharpness improvement.

To achieve a combining or mixing of these two components an image conversion unit according to the invention preferably comprises:

first computing means for computing a difference between the second filter coefficient and the predetermined filter coefficient;

second computing means for computing a weighted difference by multiplying the difference with a gain factor; and

third computing means for computing the first filter coefficient on basis of the weighted difference.

The third computing means are arranged to compute the first filter coefficient by adding the weighted difference to the predetermined filter coefficient or alternatively the third computing means are arranged to compute the first filter coefficient by adding the weighted difference to the second filter coefficient

An advantage of these latter embodiments according to the invention is that even exaggeration of the adaptivity can be achieved. Since in the case that the gain factor is higher than the unity gain then the difference between adaptive filtering and linear filtering is amplified.

In an embodiment of the image conversion unit according to the invention the coefficient-determining means comprises a predetermined Look-Up-Table for translating data which is derived from the pixel values of the group of pixels, into the second filter coefficient, the predetermined Look-Up-Table being obtained by means of a training process. An advantage of this embodiment is that the determining of the second filter coefficient requires a relatively low computing resources usage. An approach of applying a LUT for determining filter coefficients in the case of an up-conversion unit is disclosed in the cited article.

In an embodiment of the image conversion unit according to the invention the coefficient-calculating means is arranged to calculate the second filter coefficient by means of an optimization algorithm. Preferably the optimization algorithm is a Least Mean Square algorithm. An LMS algorithm is relatively simple and robust. An approach of applying an optimization algorithm for determining filter coefficients in the case of an up-conversion unit is disclosed in the cited article.

In an embodiment of the image conversion unit according to the invention the image conversion unit comprises a clipping unit to limit the second pixel value between a minimum and a maximum pixel value found in a neighborhood of the first one of the pixel values of the first image. The conversion, especially in the case of the above mentioned exaggerations might lead to overshoots. Perceptually, this leads to an improved sharpness impression, but care should be taken that these overshoots are not too strong. Therefore, the “exaggerated output signal” is (soft-) clipped between minimum and maximum pixel-values found in a spatial neighborhood. Various options exist here. The minimum and the maximum can be derived from the input image, i.e. the first image or from the output image, i.e. the second image.

It is a further object of the invention to provide an image processing apparatus of the kind described in the opening paragraph, which is arranged to provide images that are optimal in a subjective sense.

This object of the invention is achieved in that the image conversion unit further comprises control means to control the coefficient-determining means. The image processing apparatus optionally comprises a display device for displaying the second image. The image processing apparatus might e.g. be a TV, a set top box, a satellite tuner, a VCR (Video Cassette Recorder) player or a DVD (D)igital Versatile Disk) player.

It is a further object of the invention to provide a method of the kind described in the opening paragraph, which provides images that are optimal in a subjective sense.

This object of the invention is achieved in that the method further comprises control of the determination of the first filter coefficient.

It is a further object of the invention to provide a computer program product of the kind described in the opening paragraph, which provides images that are optimal in a subjective sense.

This object of the invention is achieved in that the computer program product, after being loaded, provides processing means with the capability to carry out:

determining a first filter coefficient on basis of pixel values of a group of pixels of the first image;

computing a second pixel value of the second image on basis of a first one of the pixel values of the first image and the first filter coefficient; and

control of the determination of the first filter coefficient.

Modifications of the image conversion unit and variations thereof may correspond to modifications and variations thereof of the image processing apparatus, the method and the computer program product described.

These and other aspects of the image conversion unit, of the image processing apparatus, of the method and of the computer program product according to the invention will become apparent from and will be elucidated with respect to the implementations and embodiments described hereinafter and with reference to the accompanying drawings, wherein:

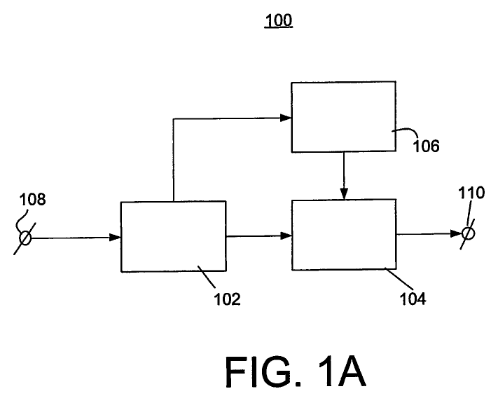

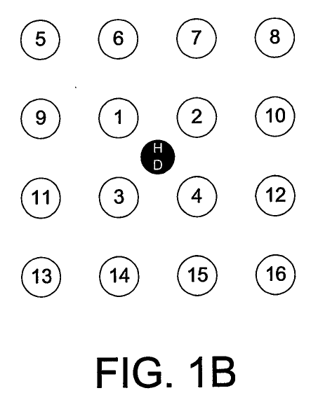

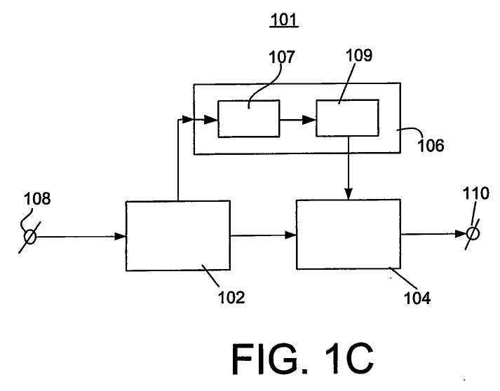

FIG. 1A schematically shows an embodiment of the image conversion unit according to the prior art;

FIG. 1B schematically shows a number of pixels to explain the method according to the prior art;

FIG. 1C schematically shows an alternative embodiment of the image conversion unit according to the prior art;

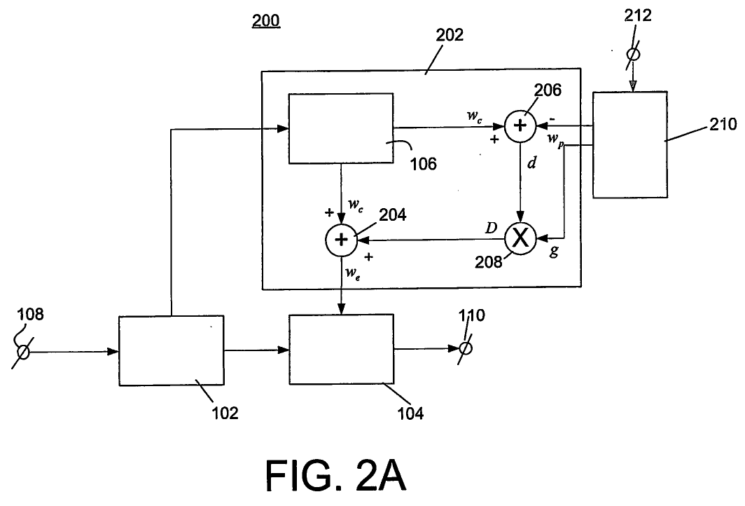

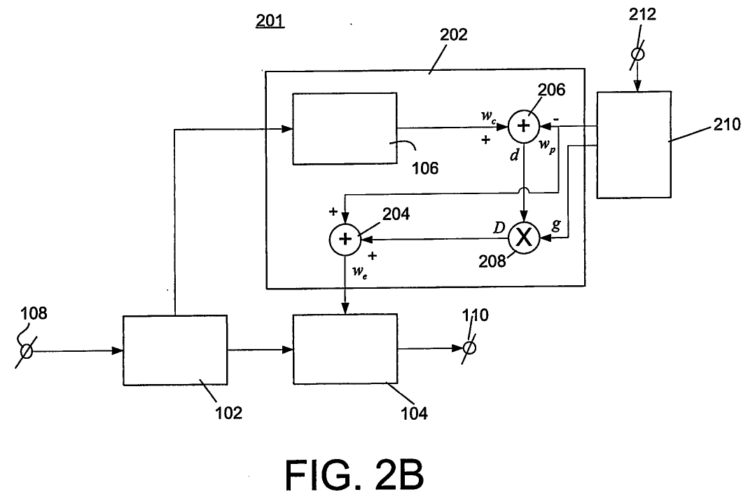

FIG. 2A schematically shows an embodiment of the image conversion unit according to the invention;

FIG. 2B schematically shows an alternative embodiment of the image conversion unit according to the invention;

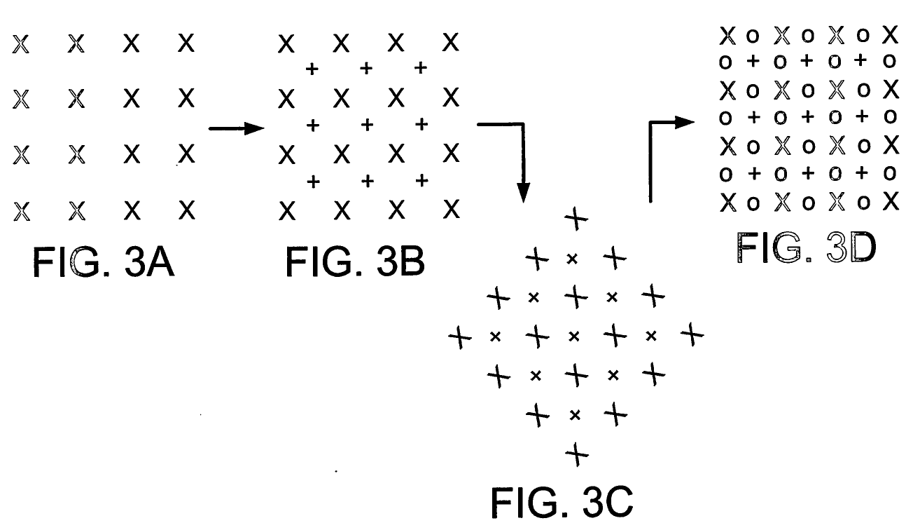

FIG. 3A schematically shows an SD input image;

FIG. 3B schematically shows the SD input image of FIG. 3A on which pixels are added in order to increase the resolution;

FIG. 3C schematically shows the image of FIG. 3B after being rotated over 45 degrees;

FIG. 3D schematically shows an HD output image derived from the SD input image of FIG. 3A; and

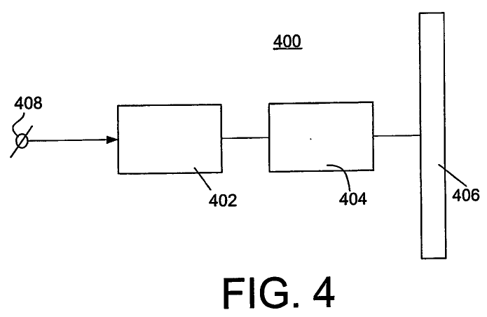

FIG. 4 schematically shows an embodiment of the image processing apparatus according to the invention.

Same reference numerals are used to denote similar parts throughout the figs.

FIG. 1A schematically shows an embodiment of the image conversion unit 100 according to the prior art The image conversion unit 100 is provided with standard definition (SD) images at the input connector 108 and provides high definition (HD) images at the output connector 110. The image conversion unit 100 comprises:

A pixel acquisition unit 102 which is arranged to acquire a first set of pixel values of pixels 1-4 (See FIG. 1B) in a first neighborhood of a particular location within a first one of the SD input images which corresponds with the location of an HD output pixel and is arranged to acquire a second set of pixel values of pixels 1-16 in a second neighborhood of the particular location within the first one of the SD input images;

A filter coefficient-determining unit 106, which is arranged to calculate filter coefficients on basis of the first set of pixel values and the second set of pixel values. In other words, the filter coefficients are approximated from the SD input image within a local window. This is done by using a Least Mean Squares (LMS) method which is explained in connection with FIG. 1B.

An adaptive filtering unit 104 for calculating the pixel value of the HD output pixel on basis of the first set of pixel values and the filter coefficients as specified in Equation 1. Hence, the filter coefficient-determining unit 106 is arranged to control the adaptive filtering unit 104.

The adaptive filtering unit 104 uses a fourth order interpolation algorithm as specified in Equation 1:

$${F}_{HD} ( 2 ( i + 1 ) , 2 ( j + 1 ) ) = {\sum }_{k = 0}^{1} {\sum }_{l = 0}^{1} {w}_{e} ( 2 k + l ) {F}_{SD} ( 2 i + 2 k , 2 j + 2 l ) \qquad ( 1 )$$

where F_{HD}(i;j) denotes the luminance values of the HD output pixels, F_{SD}(i,j) the luminance values of the input pixels and wₑ(i) the filter coefficients.

FIG. 1B schematically shows a number of pixels 1-16 of an SD input image and one HD pixel of an HD output image, to explain the method according to the prior art. The HD output pixel is interpolated as a weighted average of 4 pixel values of pixels 1-4. That means that the luminance value of the HD output pixel F_{HD} results as a weighted sum of the luminance values of its 4 SD neighboring pixels:
F_{HD}=wₑ(1)F_{SD}(1)+wₑ(2)F_{SD}(2)+wₑ(3)F_{SD}(3)+wₑ(4)F_{SD}(4) (2)
where F_{SD}(1) to F_{SD}(4) are the pixel values of the 4 SD input pixels 1-4 and wₑ(1) to wₑ(4) are the filter coefficients to be calculated by means of the LMS method. The authors of the cited article in which the prior art method is described, make the sensible assumption that edge orientation does not change with scaling. The consequence of this assumption is that the optimal filter coefficients are the same as those to interpolate, on the standard resolution grid:

Pixel 1 from 5, 7, 11, and 4 (that means that pixel 1 can be derived from its 4 neighbors)

Pixel 2 from 6, 8, 3, and 12

Pixel 3 from 9, 2, 13, and 15

Pixel 4 from 1, 10, 14, and 16

This gives a set of 4 linear equations from which with the LSM-optimization the optimal 4 filter coefficients to interpolate the HD output pixel are found.

Denoting M as the pixel set, on the SD-grid, used to calculate the 4 weights, the Mean Square Error (MSE) over set M in the optimization can be written as the sum of squared differences between original SD-pixels F_{SD} and interpolated SD-pixels F_{SI}:

$$MSE = {\sum }_{{F}_{SSD ( i , j ) = M}} {( {F}_{SD} ( 2 i + 2 , 2 j + 2 ) - {F}_{SI} ( 2 i + 2 , 2 j + 2 ) )}^{2} \qquad ( 3 )$$

Which in matrix formulation becomes:
MSE=∥\vec{y}−\vec{w}C∥² (4)
Here \vec{y} contains the SD-pixels in M (pixel F_{SD}(1,1) to F_{SD}(1,4), F_{SD}(2,1) to F_{SD}(2,4), F_{SD}(3,1) to F_{SD}(3,4), F_{SD}(4,1) to F_{SD}(4,4) and C is a 4×M² matrix whose k^{th} row contains the four diagonal SD-neighbors of the k^{th} SD-pixels in \vec{y}. The weighted sum of each row describes a pixel F_{SI}, as used in Equation 3. To find the minimum MSE, i.e. LMS, the derivation of MSE over \vec{w} is calculated:

$$\begin{matrix}\frac{\partial ( MSE )}{\partial \vec{w}} = 0 & ( 5 ) \\ - 2 \vec{y} C + 2 \vec{w} {C}^{2} = 0 & ( 6 ) \\ \vec{w} = {( {C}^{T} C )}^{- 1} ( {C}^{T} \vec{y} ) & ( 7 )\end{matrix}$$

By solving Equation 7 the filter coefficients are found and by using Equation 2 the pixel values of the HD output pixels can be calculated.

In this example a window of 4 by 4 pixels is used for the calculation of the filter coefficients. An LMS optimization on a larger window, e.g. 8 by 8 instead of 4 by 4 gives better results.

FIG. 1C schematically shows an alternative embodiment of the image conversion unit 101 according to the prior art. The filter coefficient-determining unit 106 comprises a compression unit 107 and a LUT 109 with data being derived during a training process. A compression scheme is based on detecting which of the pixels in a sliding window are above and which of the pixels in the window are below the average luminance value of the pixels in the window. This results for every position of the sliding window a pattern of zeroes (pixel values below the average luminance value) and ones (pixel values above the average luminance value). This pattern corresponds with an entry of the LUT 109. At the respective output of the LUT 109 the appropriate filter coefficients are provided for the given input. In the article “Towards an overview of spatial up-conversion techniques”, by Meng Zhao et al., in the Proceedings of the ISCE 2002, Erfurt, Germany, 23-26 Sep. 2002, this embodiment of the image conversion unit 101 according to the prior art is explained further.

FIG. 2A schematically shows an embodiment of the image conversion unit 200 according to the invention. This image conversion unit 200 basically comprises the same type of components as the image conversion units 100 and 101 as described in connection with FIG. 1A and FIG. 1C, respectively. These components are:

A pixel acquisition unit 102 which is arranged to acquire pixel values of the input image;

A filter coefficient-determining unit 106 which is arranged to compute filter coefficients on basis of the acquired pixel values; and

An adaptive filtering unit 104 for calculating the pixel values of the HD output pixels on basis of the acquired pixel values.

A difference between the image conversion unit 100-101 according to the prior art and the image conversion unit 200 according to the invention is the fact that the image conversion unit 200 according to the invention comprises control means 204-210 to control the determining of the filter coefficients that are provided to the adaptive filtering unit 104. In other words, the image conversion unit 200 according to the invention comprises a filter coefficient-computation unit 202 that comprises the known coefficient-determining unit 106. The filter coefficient-computation unit 202 further comprises:

a subtraction unit 206 for computing a difference d between an image content dependent filter coefficient w_{c} being computed by means of the coefficient-determining unit 106 and a predetermined filter coefficient wₚ being provided by a control unit 210;

a multiplier unit 208 for computing a weighted difference D by multiplying the difference d with a gain factor g being provided by the control unit 210; and

an adding unit 204 for computing the eventual filter coefficient wₑ, to be provided to the adaptive filtering unit 104, by adding the weighted difference D to the image content dependent filter coefficient w_{c}.

The operation performed by the subtraction unit 206 is given in Equation 8:
d=w_{c}−wₚ (8)
The operation performed by the multiplier unit 208 is given in Equation 9:
D=d*g (9)
The operation performed by the adding unit 204 is given in Equation 10:
wₑ=D+w_{c} (10)

By combining the Equations 8-10 the computation of the eventual filter coefficient wₑ can be given by Equation 11:
wₑ=w_{c}+g(w_{c}−wₚ)=(1+g)w_{c}−gwₚ (11)
That means that his embodiment according to the invention is arranged to compute a difference between first parameters for a content-adaptive upconversion of a group of pixels and second parameters for a non content-adaptive upconversion (linear) of the group of pixels. In general, the content-adaptive upconversion results in enhanced sharpness while the linear upconversion only results in additional pixels. The computed difference is applied to control the amount of sharpness enhancement. The difference signal is multiplied by a gain factor and added to the first parameters. Depending on the gain it is possible to achieve a sharpness enhancement that is lower or higher than what is achieved in the case of content-adaptive upconvers ion based on a predetermined optimization criterion.

The effect of the image conversion unit 200, in particular of the filter coefficient-computation unit 202, is explained by means of a numerical example. Suppose there are four SD pixels disposed in a square. The value of an HD pixel in the middle of the square has to be computed on basis of interpolation of the four SD pixels. In case of linear interpolation the following predetermined filter coefficients could be applied, i.e. wₚ(1)=¼; wₚ(2)=¼; wₚ(3)=¼; wₚ(4)=¼. Suppose that the filter coefficient-determining unit 106 determines the following image content dependent filter coefficients for the four SD pixels: w_{c}(1)= 1/2; w_{c}(2)=0; w_{c}(3)=½; w_{c}(4)=0. With Equation 8 the following differences are computed, d(i)=(½; 0; ½; 0)−( 1/4; − 1/4; 1/4; −1/4)=(¼; −¼; ¼; −¼). With Equation 10 and in the case of unity gain the following filter coefficients are computed: wₑ(i)=(¼; −¼; ¼; −¼)+(½; 0; ½; 0)=(3/4; −¼; 3/4; −¼). These four filter coefficients are provided to the adaptive filtering unit 104, which computes the value of the HD pixel as specified in Equation 2.

The gain g and the predetermined filter coefficients wₚ(i) are provided by means of the control unit 210. This control unit 210 has an external interface 212 via which user input data is accepted. This control unit 210 is arranged to translate the user input data into the appropriate set of values for the gain g and the predetermined filter coefficients wₚ(i).

The pixel acquisition unit 102, the filter coefficient-computation unit 202, the control unit 210 and the adaptive filtering unit 104 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 2B schematically shows an alternative embodiment of the image conversion unit 201 according to the invention. A difference between this embodiment 201 and the embodiment 200 described in connection with FIG. 2A is that the adding unit 204 is arranged to compute the eventual filter coefficient wₑ, to be provided to the adaptive filtering unit 104, by adding the weighted difference D to the predetermined filter coefficient wₚ. That means that the operation performed by the adding unit 204, is given by Equation 12:
wₑ=D+wₚ (12)
Combining the Equations 8, 9 and 12, the computation of the eventual filter coefficient wₑ of the image conversion unit 201 can be given by Equation 13:
wₑ=wₚ+g(w_{c}−wₚ)=gwₑ+(1−g)wₚ (13)
It will be clear that further alternative embodiments are possible. E.g. the subtraction unit 206 for computing a difference d between an image content dependent filter-coefficient w_{c} being computed by means of the coefficient-determining unit 106 and a predetermined filter coefficient wₚ being provided by a control unit 210 might operate in an opposite sense as specified in Equation 8. That means that the operation performed by the subtraction unit 206, is given by Equation 14:
d=wₚ−w_{c} (14)
In that case the following computations for the eventual filter coefficient wₑ are applicable:
wₑ=w_{c}+g(wₚ−w_{c})=(g−1)w_{c}+gwₚ (15)
or
wₑ=wₚ+g(wₚ−w_{c})=−gw_{c}+(1+g)wₚ (16)

To convert an SD input image into an HD output image a number of processing steps are needed. By means of FIGS. 3A-3D these processing steps are explained. FIG. 3A schematically shows an SD input image; FIG. 3D schematically shows an HD output image derived from the SD input image of FIG. 3A and FIGS. 3B and 3C schematically show intermediate results.

FIG. 3A schematically shows an SD input image. Each X-sign correspond with a respective pixel.

FIG. 3B schematically shows the SD input image of FIG. 3A on which pixels are added in order to increase the resolution. The added pixels are indicated with +-signs. These added pixels are calculated by means of interpolation of the respective diagonal neighbors. The filter coefficients for the interpolation are determined as described in connection with FIG. 2A or FIG. 2B.

FIG. 3C schematically shows the image of FIG. 3B after being rotated over 45 degrees. The same image conversion unit 200 as being applied to calculate the image as depicted in FIG. 3B on basis of FIG. 3A can be used to calculate the image as shown in FIG. 3D on basis of the image as depicted in FIG. 3B. That means that new pixel values are calculated by means of interpolation of the respective diagonal neighbors. Notice that a first portion of these diagonal neighbors (indicated with X-signs) correspond to the original pixel values of the SD input image and that a second portion of these diagonal neighbors (indicated with +-signs) correspond to pixel values which have been derived from the original pixel values of the SD input image by means of interpolation.

FIG. 3D schematically shows the final HD output image. The pixels that have been added in the last conversion step are indicated with o-signs.

FIG. 4 schematically shows an embodiment of the image processing apparatus 400 according to the invention, comprising:

receiving means 402 for receiving a signal representing SD images;

the image conversion unit 404 as described in connection with any of the FIGS. 2A-2B; and

a display device 406 for displaying the HD output images of the image conversion unit 404. This display device 406 is optional.

The signal may be a broadcast signal received via an antenna or cable but may also be a signal from a storage device like a VCR (Video Cassette Recorder) or Digital Versatile Disk (DVD). The signal is provided at the input connector 408. The image processing apparatus 400 might e.g. be a TV. Alternatively the image processing apparatus 400 does not comprise the optional display device but provides HD images to an apparatus that does comprise a display device 406. Then the image processing apparatus 400 might be e.g. a set top box, a satellite-tuner, a VCR player or a DVD player. But it might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image conversion unit (200) for converting a first image with a first resolution into a second image with a second resolution being different from the first resolution, the image conversion unit (200) comprising:
a coefficient-determining means (202) for determining a first filter coefficient on basis of pixel values of a group of pixels of the first image; and
an adaptive filtering means (104) for computing a second pixel value of the second image on basis of a first one of the pixel values of the first image and the first filter coefficient, characterized in that the image conversion unit (200) comprises control means (204-210) to control the determination of the first filter coefficient.

2. An image conversion unit (200) as claimed in claim 1, characterized in being arranged to compute the first filter coefficient by combining a second filter coefficient, which is based on the pixel values of the group of pixels, with a predetermined filter coefficient, the combining controlled by the control means (210)

3. An image conversion unit (200) as claimed in claim 2, characterized in comprising:
first computing means (206) for computing a difference between the second filter coefficient and the predetermined filter coefficient;
second computing means (208) for computing a weighted difference by multiplying the difference with a gain factor; and
third computing means (204) for computing the first filter coefficient on basis of the weighted difference.

4. An image conversion unit (200) as claimed in claim 3, characterized in that third computing means (204) are arranged to compute the first filter coefficient by adding the weighted difference to the predetermined filter coefficient.

5. An image conversion unit (200) as claimed in claim 3, characterized in that third computing means (204) are arranged to compute the first filter coefficient by adding the weighted difference to the second filter coefficient.

6. An image conversion unit (200) as claimed in claim 1, characterized in that the coefficient-determining means (202) comprises a predetermined Look-Up-Table for translating data which is derived from the pixel values of the group of pixels, into the second filter coefficient, the predetermined Look-Up-Table being obtained by means of a training process.

7. An image conversion unit (200) as claimed in claim 1, characterized in that the coefficient-determining means (202) are arranged to compute the second filter coefficient by means of an optimization algorithm.

8. An image conversion unit (200) as claimed in claim 1, characterized in that the image conversion unit (200) comprises a clipping unit to limit the second pixel value between a minimum and a maximum pixel value found in a neighborhood of the first one of the pixel values of the first image.

9. An image processing apparatus (400), comprising:
receiving means (402) for receiving a signal corresponding to a first image; and
an image conversion unit (200) for converting the first image into a second image, the image conversion unit (200) as claimed in claim 1.

10. An image processing apparatus (400) as claimed in claim 9, characterized in further comprising a display device (406) for displaying the second image.

11. An image processing apparatus (400) as claimed in claim 10, characterized in that it is a TV.

12. A method of converting a first image with a first resolution into a second image with a second resolution being different from the first resolution, the method comprising:
determining a first filter coefficient on basis of pixel values of a group of pixels of the first image; and
computing a second pixel value of the second image on basis of a first one of the pixel values of the first image and the first filter coefficient, characterized in comprising control of the determination of the first filter coefficient.

13. A computer program product to be loaded by a computer arrangement, comprising instructions to convert a first image with a first resolution into a second image with a second resolution being different from the first resolution, the computer arrangement comprising processing means and a memory, the computer program product, after being loaded, providing said processing means with the capability to carry out:
determining a first filter coefficient on basis of pixel values of a group of pixels of the first image;
computing a second pixel value of the second image on basis of a first one of the pixel values of the first image and the first filter coefficient; and
control of the determination of the first filter coefficient.
